(19) United States
(12) Patent Application Publication
(10) Pub. No.: US 2006/0068088 A1
(43) Pub. Date: Mar. 30, 2006

(54) Chemical mechanical polishing pad with micro-mold and production method thereof

(76) Inventors: Hae-Do Jeong, Busan (KR); Jae-Young Choi, Busan (KR); Hyoung-Jae Kim, Busan (KR); Heon-Deok Seo, Busan (KR); Boum-Young Park, Busan (KR); Jae-Hong Park, Busan (KR)

Correspondence Address: ST. ONGE STEWARD JOHNSTON & REENS, LLC, 986 BEDFORD STREET, STAMFORD, CT, 06905-5619, US

(21) Appl. No.: 10/952,292

(22) Filed: Sep. 28, 2004

(51) Int. Cl. B28B 7/38

(52) U.S. Cl. 427/133

(57) ABSTRACT

The present invention relates to a chemical mechanical polishing (CMP) pad with a micro-mold, and a production method thereof. More particularly, the present invention relates to a CMP pad with a micro-mold, in which the surface of the CMP pad is uniformly formed so as to avoid the glazing of the polishing pad, prevent a change in slurry flow and maintain the contact area between the polishing pad and a semiconductor wafer constant, thus allowing the wafer to be polished in a continuous and stable manner, and permitting the semiconductor wafer to be polished into the desired shape, as well as a production method thereof.

### FIELD OF THE INVENTION

The present invention relates to a chemical mechanical polishing (CMP) pad with a micro-mold, and a production method thereof. More particularly, the present invention relates to a CMP pad with a micro-mold, in which the surface of the CMP pad is uniformly formed to avoid the glazing of the polishing pad, prevent a change in slurry flow and maintain the contact area between the polishing pad and a semiconductor wafer constant, thus allowing the wafer to be polished in a continuous and stable manner and permitting the semiconductor wafer to be polished into the desired shape, as well as a production method thereof.

### BACKGROUND OF THE RELATED ART

A manufacturing process for semiconductor devices is based on forming metal interconnections, insulting films and interlayer insulating films by several processes, such as CVD, PVD and etching. Between these processes, processes of flattening the surface at the end of each process are conducted.

The flattening processes now become almost necessary, since semiconductor devices have a multilayer structure in the inside thereof with an increase in the integration density of the semiconductor devices so that the minimum linewidth of each of patterns is gradually decreased. The flattening processes are intended to include all improving the planarization of the surface to be processed and removing the surface of a thin film uniformly. Among them, a flattening process after an insulating process in processes of making devices or after a sputtering process for forming interlayer insulation films is very important.

After the insulating process and the sputtering process, operations of selectively removing protrusions formed on a concave/convex surface to flatten the surface are required. Moreover, operations by which different materials of metal interconnection and insulating films, such as oxides and nitrides, are removed uniformly at the same time are also required.

The flattening process is critical to secure the focus depth of a light source in an exposure process among semiconductor device processes.

For the flattening process, various techniques including spin-on-glass (SOG) and etch-back were carried out in the prior art. Recently, chemical mechanical polishing in which mechanical polishing and chemical polishing are conducted at the same time is frequently conducted. The chemical mechanical polishing is currently widely used since it enjoys both the advantages of the mechanical polishing and the advantages of the chemical polishing.

FIG. 1 is a schematic diagram showing a general CMP apparatus. Referring to FIG. 1, a polishing pad used to polish a semiconductor wafer is attached to the upper surface of a rotation table. On the upper surface of the polishing pad, a wafer carrier having a wafer attached thereto is disposed such that it is contact with the polishing pad. The wafer carrier is made in close contact with the pad by a given pressure while it undergoes not only rotation movement but also oscillation movement. The movement of the wafer carrier polishes and flattens the surface of the semiconductor wafer together with the rotation movement of the rotation table.

While the polishing process is conducted, slurry is continuously fed between the wafer and the pad by means of a slurry-feeding device. After completion of the polishing process, conditioning operation is performed on the upper surface of the pad by a conditioner.

The conditioning operation is to form a new surface of the pad by a micro-removal operation for the pad surface. The conditioning operation is made mainly by means of a diamond disc.

FIG. 2 is a microphotograph showing the composition of the prior polishing pad. Referring to FIG. 2, the polishing pad is generally made of polyurethane foams and has a number of pores. The pores are empty spaces which are artificially formed during the production of the polishing pad. The pores are produced in a polyurethane foaming process and have a size of 30-100 μm. Generally, the pores make up about 50% by volume of the polyurethane foams.

Each of the pores comprise a pore wall which will come in contact with a wafer to be polished. The pore wall serves to prevent the slurry fed onto the polishing pad surface from flowing to the outside. The slurry stored within the pore wall is fed when the wafer is polished.

The prior CMP pad has the following problems. First, the distribution of pores which will come in contact with the wafer is not uniform so that the flow of the slurry will be inconstant. This will adversely affect a flattening process after the processing of the wafer.

The actual contact area between the wafer and the pore walls will vary during the process, so that a pressure applied to the slurry pad surface will vary. This will also adversely affect the operation of flattening the wafer surface.

Furthermore, treating agents or polishing particles will be aggregated within the pores, thus causing a grazing phenomenon. If the grazing in the pores occurs, the slurry cannot be smoothly supplied between the pore wall and the wafer.

Thus, if the slurry supply is not uniformly made due to these phenomena or the slurry supply itself is blocked due to these phenomena, the wafer cannot be uniformly polished.

### SUMMARY OF THE INVENTION

The present invention has been made to solve the above-mentioned problems occurring in the prior art, and it is an object of the present invention to provide a method for producing a CMP pad with a micro-mold, in which the desired shapes are uniformly formed on the surface of the polishing pod by a micro-molding technique so as to allow slurry to be distributed uniformly and to make a pressure acting on the entire surface of a wafer uniform, thus allowing the wafer to be polished uniformly.

Another object of the present invention is to provide a method for producing a CMP pad with a micro-mold, which allows the self-conditioning of the pad so as to eliminate a need for dressing operations.

Still another object of the present invention is to provide a method for producing a CMP pad with a micro-mold, which prevents the non-uniformity of the pad surface and avoids the glazing of the polishing pad, such that a change in slurry flow and a change in contact area can be prevented from occurring and a semiconductor wafer can be polished in a continuous and stable manner.

To achieve the above objects, in a preferred embodiment, the present invention provides a method for producing a CMP pad with a micro-mold, the method comprising the steps of: making a micro-mold into the shape of a polishing pad such that 1-50% of the area of the polishing pad will be in contact with a wafer and the size of contacting protrusions will be 20-500 μm; mixing hydrophilic polymers and urethane with each other at a ratio of 10-20:80-90 so as to prepare a polymer mixture; applying the polymer mixture on the surface of the micro-mold to a thickness of 3-8 mm and then degassing the applied polymer mixture using a vacuum casting machine; bake-hardening the resulting micro-mold in an oven at a temperature of 50-70° C. for 23-25 hours; coating the surface of the micro-mold with a polycarbonate film by a rolling process; and hardening the polycarbonate film with an UV lamp.

The contacting protrusions can be formed into the shape of a hexahedron, a cylinder or a triangular pyramid.

The hydrophilic polymers used in the inventive method are preferably a 5:4:1 mixture of PEGMA, PEG and TMPTA.

The polymer mixture may additionally contain an initiator in the amount of about 0.5-1.5% relative to the weight of the polymer mixture.

### BRIEF DESCRIPTION OF DRAWINGS

The above and other objects, features and advantages of the present invention will be more clearly understood from the following detailed description taken in conjunction with the accompanying drawings, in which:

FIG. 1 is a schematic diagram showing a prior CMP apparatus;

FIG. 2 is a microphotograph showing the composition of a prior polishing pad;

FIG. 3 is a process flow chart showing a production process of a CMP pad according to a preferred embodiment of the present invention;

FIG. 4 is a schematic diagram showing a production process of a CMP pad according to a preferred embodiment of the present invention; and

FIG. 5 is a photograph showing a CMP pad according to a preferred embodiment of the present invention.

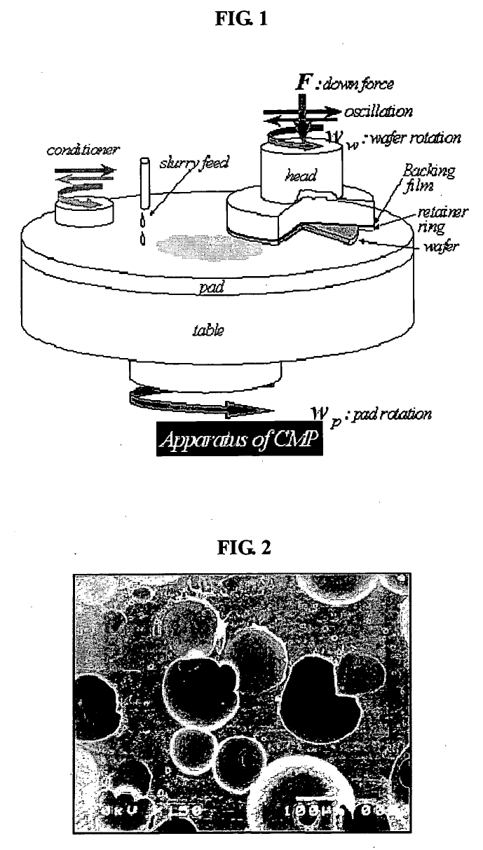

### DETAILED DESCRIPTION OF PREFERRED EMBODIMENT

Hereinafter, the inventive CMP pad with the micro-mold and the production method thereof will be described in more detail with reference to the accompanying drawings.

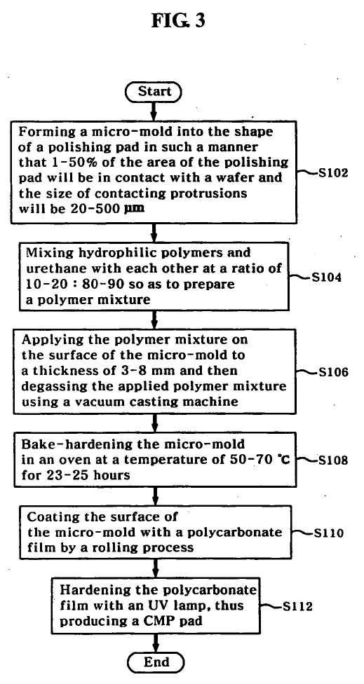

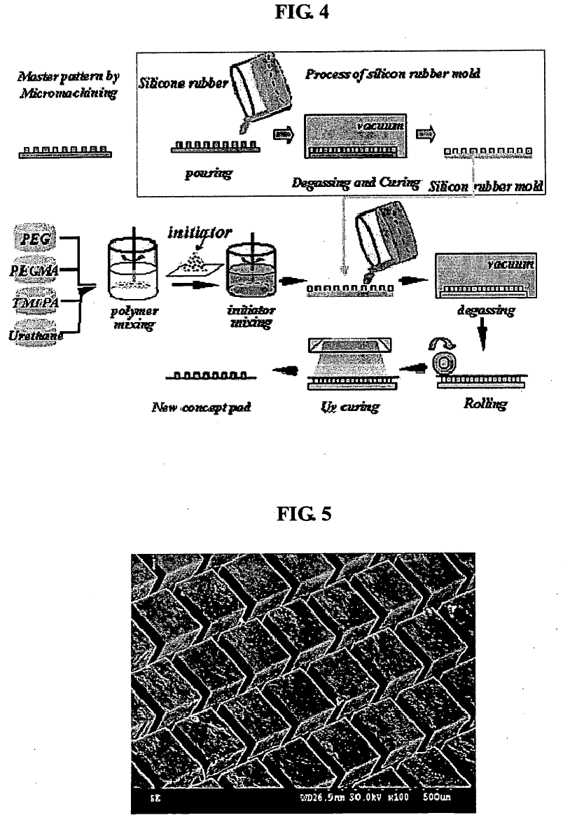

FIGS. 3 and 4 are a flow chart and a schematic diagram which show the production method of the CMP pad according to a preferred embodiment of the present invention. Referring to FIGS. 3 and 4, a micro-mold is first made into the shape of a polishing pad. Then, a polymer mixture is applied on the micro-mold surface and hardened.

Methods which are mainly used to make the micro-mold include two methods, one using a silicon process, and the other using a micro-rapid prototyping process.

The micro-mold is designed in such a manner that 1-50% of the area of a polishing pad will be in contact with a wafer, and the size of contacting protrusions will be 20-500 μm. The greatest effect will be obtained when about 5% of the polishing pad area is in contact with the wafer. The contact area can also be widened depending on the production process of the polishing pad and the shape of wafer patterns. However, the contact area of the polishing pad is preferably in a range of 1-50%.

The size of the contacting protrusions is determined based on the thickness of commercial polishing pads. A further increase in the polishing pad thickness results in deterioration in the elastic and viscoelastic properties of the polishing pad, thus adversely affecting the results of polishing.

Next, hydrophilic polymers and urethane are mixed with each other at a ratio of 10-20:80-90 so as to prepare a polymer mixture. In this step, PEGMA, PEG and TMPTA, which are hydrophilic polymers, are first mixed at a ratio of 5:4:1. Then, the polymers and urethane are mixed at a ratio of 10-20:80-90. If necessary, an initiator may also be added to the polymer mixture.

Hydrophilic polymers have a characteristic in that they are swollen upon contact with water. The polymer swelling refers to a phenomenon where the linking chains of hydrophilic polymers are loose so as to soften the polymer surface, when the polymers come in contact with water to absorb water. The use of this polymer swelling allows the self-conditioning of the polishing pad, since the swollen polymers are minutely separated in themselves by a pressure caused by the contact between the wafer and the polishing pad. The urethane serves to enhance the durability, strength and ductility of the polishing pad.

If necessary, the hardening initiator may be added and selected from a liquid photoinitiator and a bake hardening initiator. Furthermore, processes of hardening the micro-mold are broadly divided into a light hardening process and a bake hardening process.

The light hardening process has an advantage in that it allows polishing pads to be produced in a rapid and continuous manner. However, it has a disadvantage in that it is difficult to manufacture thick pads since a depth to which UV infiltrates is small. As the photoinitiatior, initiators manufactured by Ciba Co. are mainly used.

The bake hardening process has an advantage in that it allows pads to be manufactured without limitations on the pad thickness or size. However, it has disadvantages in that it requires a long time and can cause thermal deformation. As the bake hardening initiator, benzoyl peroxide is mainly used.

Then, a step of applying the polymer mixture on the micro-mold and then degassing the polymer mixture using a vacuum casting machine is performed. In this step, the polymer mixture is poured onto the surface of the produced micro-mold to a thickness of 3-8 mm. Then, in order that bubbles do not occur during the production of the polishing pad, the polymer mixture is completely degassed using the vacuum casting machine. By this step, the polymer mixture is easily filled into microspaces formed in the micro-mold.

After conducting the degassing operation in the vacuum casting machine, the micro-mold is subjected to bake hardening in an oven, thus completing the fabrication of the micro-mold. The bake hardening step is preferably conducted at a temperature of 55-65° C. for 23-25 hours.

Then, a step of coating the surface of the micro-mold with a polycarbonate film by a rolling process is performed. In this step, the micro-mold is taken out from the vacuum casting machine, and then the polycarbonate film is coated on the upper surface of the micro-mold by the rolling process. The polycarbonate film has low deformation occurred, thus improving the durability of the polishing pad.

Finally, a UV (ultraviolet) lamp is used to harden the polycarbonate film, thus completing the production of the polishing pad. By hardening with the UV lamp, the surface of the polishing pad becomes uniform.

Because the surface of the polishing pad is uniformly formed, the glazing of the polishing pad surface will be prevented from occurring. Also, slurry flow will be maintained constant, and the contact area between the polishing pad and a semiconductor wafer will be maintained constant. Thus, the semiconductor wafer is polished into the desired shape.

FIG. 5 is a photograph showing the CMP pad according to the preferred embodiment of the present invention. As shown in FIG. 5, according to the inventive method for producing the CMP pad, the CMP pad having a uniform and constant shape is formed. This provides an advantage in that the glazing of the polishing pad surface will be prevented.

Also, a change in slurry flow will be prevented, and the contact area between the polishing pad and the wafer will be maintained constant. Thus, the semiconductor wafer will be polished in a continuous and stable manner. Also, the semiconductor wafer will be polished into the desired shape.

As described above in detail, the present invention has an advantage in that it allows the surface of the polishing pad to be formed uniformly, so that the glazing of the polishing pad will be prevented.

Also, by such an advantage, a change in slurry flow will be prevented and the contact area between the polishing pad and the semiconductor wafer will be maintained constant. Thus, semiconductor wafer will be polished in a continuous and stable manner. In addition, the semiconductor wafer can be polished into the desired shape.

The features and technical advantages of the present invention have been broadly described above in order to provide a better understanding of the accompanying claims. Additional features and advantages constituting the claims will be described in detail below. It should be appreciated by a person skilled in the art that the disclosed concept and specific embodiment of the present invention will be ready to use as a base for the design or modification of other structures for performing a similar purpose to the present invention.

Furthermore, it will be understood by a person skilled in the art that the inventive concept and embodiment disclosed in the present invention can be used as a base for the modification or design of other structure for performing the same purpose as in the present invention. Also, those skilled in the art will appreciate that various modifications, additions and substitutions are possible, without departing from the scope and spirit of the invention as disclosed in the accompanying claims.

What is claimed is:

1. A method for producing a CMP pad with a micro-mold, the method comprising the steps of:
making a micro-mold into the shape of a polishing pad such that 1-50% of the area of the polishing pad will be in contact with a wafer and the size of contacting protrusions will be 20-500 μm;
mixing hydrophilic polymers and urethane with each other at a ratio of 10-20:80-90 so as to prepare a polymer mixture;
applying the polymer mixture on the surface of the micro-mold to a thickness of 3-8 mm and then degassing the applied polymer mixture using a vacuum casting machine;
bake-hardening the resulting micro-mold in an oven at a temperature of 50-70° C. for 23-25 hours;
coating the surface of the micro-mold with a polycarbonate film by a rolling process; and
hardening the polycarbonate film with an UV lamp, thus producing a CMP pad.

2. The method of claim 1, wherein the contacting protrusions are formed into the shape of a hexahedron, a cylinder or a triangular pyramid.

3. The method of claim 1, wherein the hydrophilic polymers are a 5:4:1 mixture of PEGMA, PEG and TMPTA.

4. The method of claim 1, wherein the polymer mixture additionally contain an initiator in the amount of about 0.5-1.5% relative to the weight of the polymer mixture.

5. A CMP pad with a micro-mold, the CMP pad being produced by a method as set forth in claim 1.
